(19) United States
(12) Patent Application Publication
(10) Pub. No.: US 2019/0219669 A1
(43) Pub. Date: Jul. 18, 2019

(54) SIGNAL PROCESSING DEVICE, SIGNAL PROCESSING METHOD, AND SIGNAL RECEPTION DEVICE

(71) Applicant: Sony Corporation, Tokyo (JP)

(72) Inventors: Sachio Iida, Kanagawa (JP); Kenichi Kawasaki, Tokyo (JP); Hiroyuki Yamagishi, Tokyo (JP)

(21) Appl. No.: 16/308,142

(22) PCT Filed: May 17, 2017
(86) PCT No.: PCT/JP2017/018471

§ 371 Date: Dec. 7, 2018

(30) Foreign Application Priority Data
Jun. 21, 2016 (JP) 2016-122438

(51) Int. Cl. G01S 7/03

(52) U.S. Cl. CPC G01S 7/03

(57) ABSTRACT

[Object] To provide a signal processing device capable of enabling phase detection and achieving enhanced azimuth resolution with a small number of antenna elements.

[Solution] There is provided a signal processing device including: a matrix generation unit configured to generate a matrix by multiplying a received signal vector of a reception signal by a transpose vector of the received signal vector, the reception signal being received by a reception array antenna including a plurality of reception antennas; and an estimation unit configured to estimate at least a phase of the reception signal on a basis of the matrix.

### TECHNICAL FIELD

The present disclosure relates to a signal processing device, a signal processing method, and a signal reception device.

### BACKGROUND ART

The use of radar instead of cameras or the use of radar for user interface operated by gesture input is considered to protect the privacy of monitoring or care. The radar system used for these purposes is necessary to equip with a function of detecting minute movement caused by the breathing, heartbeat, fingertip, or the like of a target, so variation in phases of a radar echo signal is used. In addition, the radar system used for these purposes is desirable to have small size from the viewpoint of ease of installation and further is necessary to have the azimuth resolution to classify a plurality of targets.

To reduce the size of the radar system, it is effective to shorten the length of an aperture by reducing the number of elements of an array antenna. The aperture length and the azimuth resolution are proportional to each other. Thus, in related art, the virtual extension of the number of elements of the antenna by combining copies of a radar echo signal in such a manner that the phases are continuous is disclosed in Patent Literature 1. In addition, the compensation of the aperture length by virtual extension of the number of elements of the antenna by performing the extended array processing using the Khatri-Rao product from the correlation matrix of radar echo signals is disclosed in Non-Patent Literature 1.

### CITATION LIST

### Patent Literature

Patent Literature 1: JP 2013-217884A

### Non-Patent Literature

Non-Patent Literature 1: “DOA estimation of quasi-stationary signals with less sensors than sources and unknown spatial noise covariance: A Khatri-Rao subspace approach”, by W. K. Ma, T. H. Hsien, and C. Y. Chi, in IEEE Transactions on Signal Processing, vol. 58, no. 4, pp. 2168-2180, April 2010

### DISCLOSURE OF INVENTION

### Technical Problem

In view of the above circumstances, it is desirable to enable phase detection that failed to be achieved from the extended array processing in related art and to achieve enhanced azimuth resolution with a small number of antenna elements particularly in a compact radar system.

Thus, the present disclosure provides a novel and improved signal processing device, signal processing method, and signal reception device, capable of enabling phase detection and achieving enhanced azimuth resolution with a small number of antenna elements.

### Solution to Problem

According to the present disclosure, there is provided a signal processing device including: a matrix generation unit configured to generate a matrix by multiplying a received signal vector of a reception signal by a transpose vector of the received signal vector, the reception signal being received by a reception array antenna including a plurality of reception antennas; and an estimation unit configured to estimate at least a phase of the reception signal on a basis of the matrix.

In addition, according to the present disclosure, there is provided a signal processing method including: generating a matrix by multiplying a received signal vector of a reception signal by a transpose vector of the received signal vector, the reception signal being received by a reception array antenna including a plurality of reception antennas; and estimating at least a phase of the reception signal on a basis of the matrix.

In addition, according to the present disclosure, there is provided a signal reception device including: a reception array antenna including a plurality of reception antennas arranged at a predetermined interval; a matrix generation unit configured to generate a matrix by multiplying a received signal vector of a reception signal received by the reception array antenna by a transpose vector of the received signal vector; and an estimation unit configured to estimate at least a phase of the reception signal on a basis of the matrix.

### Advantageous Effects of Invention

According to the present disclosure as described above, there is provided a novel and improved signal processing device, signal processing method, and signal receiving device, capable of enabling phase detection and achieving enhanced azimuth resolution with a small number of antenna elements.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram illustrated to describe an exemplary configuration of a radar system according to a first example of an embodiment of the present disclosure.

FIG. 2 is a diagram illustrated to describe a radar echo signal s shown on a complex plane.

FIG. 3 is a flowchart illustrating an operation example of a radar system 1 according to the first example of the present embodiment.

FIG. 4 is a diagram illustrated to describe an exemplary configuration of radar system according to a second example of the present embodiment.

FIG. 5 is a diagram illustrated to describe an example of use of a radar system.

FIG. 6 is a diagram illustrated to describe an example of use of a radar system.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Moreover, the description will be given in the following order.

1. Embodiment of present disclosure

### 1.1. Overview

1.2. First example
1.3. Second example
2. Concluding remarks

### 1. Embodiment of Present Disclosure

### 1.1. Overview

An overview of an embodiment of the present disclosure is described and then the embodiment of the present disclosure is described in detail.

As described above, the use of radar instead of cameras or the use of radar for user interface operated by gesture input is considered to protect the privacy of monitoring or care. The radar system used for these purposes is necessary to equip with a function of detecting minute movement caused by the breathing, heartbeat, fingertip, or the like of a target, so variation in phases of a radar echo signal is used. In addition, the radar system used for these purposes is desirable to have small size from the viewpoint of ease of installation and further is necessary to have the azimuth resolution to classify a plurality of targets.

To reduce the size of the radar system, it is effective to shorten the length of an aperture by reducing the number of elements of an array antenna. The aperture length and the azimuth resolution are proportional to each other. Thus, in related art, the virtual extension of the number of elements of the antenna by combining copies of a radar echo signal in such a manner that the phases are continuous is disclosed in Patent Literature 1. In addition, the compensation of the aperture length by virtual extension of the number of elements of the antenna by performing the extended array processing using the Khatri-Rao product from the correlation matrix of radar echo signals is disclosed in Non-Patent Literature 1.

However, the method of combining copies of radar echo signals as disclosed in Patent Literature 1 is necessary to adjust phases of two data to be coincident with each other at the time of combination. In addition, in the method of performing the extended array processing from the correlation matrix of the received signal as disclosed in Non-Patent Literature 1, the phase information included in the radar echo signal is completely lost. Thus, in a case where it is necessary to detect minute movement of a target from the variation in phases of the radar echo signal, the methods fail to be used for a radar system intended to monitor or care for, in one example, a person or an animal.

Thus, for a radar system intended for monitoring or care, which is necessary to have a function of detecting minute movement of a target, it is preferable to have enhanced azimuth resolution with a small number of antenna elements while enabling phase detection.

Thus, in view of the above-mentioned points, those who conceived the present disclosure have conducted intensive studies on the technology capable of enabling phase detection that failed to be achieved from the extended array processing in related art and enhancing the azimuth resolution with a small number of antenna elements. Accordingly, those who conceived the present disclosure have devised the technology capable of enabling phase detection and enhancing the azimuth resolution with a small number of antenna elements as described below.

The overview of the embodiment of the present disclosure is described above. Then, the embodiment of the present disclosure is described in detail.

### 1.2. First Example

### (Exemplary Configuration of Radar System)

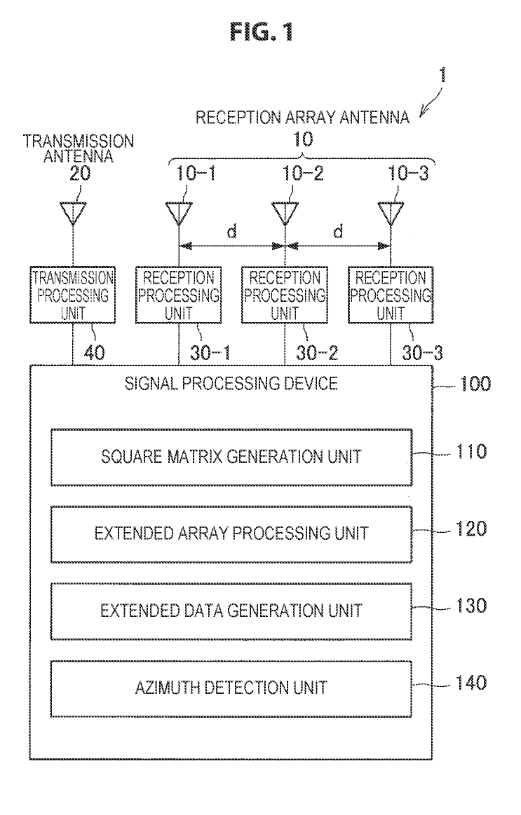

A first example of the embodiment of the present disclosure is now described. FIG. 1 is a diagram illustrated to describe an exemplary configuration of a radar system according to the first example of the embodiment of the present disclosure. An exemplary configuration of the radar system according to the first example of the embodiment of the present disclosure is described below with reference to FIG. 1.

As illustrated in FIG. 1, the radar system 1 according to the first example of the embodiment of the present disclosure includes a reception array antenna 10, a transmission antenna 20, reception processing units 30-1, 30-2, and 30-3, a transmission processing unit 40, and a signal processing device 100.

The transmission antenna 20 transmits a radar signal generated by the transmission processing unit 40. The reception array antenna 10 including reception antennas 10-1, 10-2, and 10-3 receives a radar echo signal in which the radar signal transmitted from the transmission antenna 20 is reflected from a target. The reception antennas 10-1, 10-2, and 10-3 output the received radar echo signals to the reception processing units 30-1, 30-2, and 30-3, respectively. In the present example, the reception array antenna 10 has three elements that are linearly arranged at equal intervals of a distance d between the elements.

Here, the mode vector a_{RX} of the reception array antenna 10 is shown in Formula 1.

$$\begin{matrix}[ Math . 1 ] & \\ {a}_{RX} ( ϕ ) = [ \begin{matrix}{e}^{- 1 j ϕ} \\ 1 \\ {e}^{+ 1 j ϕ}\end{matrix} ] & ( Formula 1 )\end{matrix}$$

In Formula 1, ψ is a value determined by the distance d between elements of the reception array antenna 10, the wavelength λ of the radar signal, and the arrival angle θ of the radar echo signal, and specifically expressed as Formula 2 below. The distance d between elements of the reception array antenna 10 is typically set to 0.5 wavelengths that sample the space twice per wavelength to prevent the occurrence of grating lobes.

$$\begin{matrix}[ Math . 2 ] & \\ ϕ = \frac{2 π}{λ} d sin ( θ ) & ( Formula 2 )\end{matrix}$$

The reception processing units 30-1, 30-2, and 30-3 perform predetermined processing, for example, amplification, frequency conversion, and frequency filtering on the radar echo signal s that arrives at the reception array antenna 10. Then, the reception processing units 30-1, 30-2, and 30-3 output a received signal vector X having, as elements, digital signals x1, x2, and x3 respectively obtained by analog-digital conversion of the radar echo signal s that arrives at the reception array antenna 10 to the signal processing device 100. The received signal vector X can be represented as the product of the radar echo signal s and the mode vector a_{RX} as shown in Formula 3 below.

$$\begin{matrix}[ Math . 3 ] & \\ X = [ \begin{matrix}{x}_{1} \\ {x}_{2} \\ {x}_{3}\end{matrix} ] = s \cdot {a}_{RX} ( ϕ ) & ( Formula 3 )\end{matrix}$$

The signal processing device 100 includes a square matrix generation unit 110, an extended array processing unit 120, an extended data generation unit 130, and an azimuth detection unit 140.

### (Square Matrix Generation Unit 110)

The square matrix generation unit 110 performs a calculation on the received signal vector X that is output by the reception processing units 30-1, 30-2, and 30-3 to generate a predetermined matrix. In the present embodiment, the square matrix generation unit 110 multiplies the received signal vector X by the transpose vector of X to generate a square matrix S_{XX}. The square matrix generation unit 110 outputs the generated square matrix S_{XX} to the extended array processing unit 120.

The square matrix S_{XX} generated by the square matrix generation unit 110 is the product of the square of the radar echo signal s, the mode vector a_{RX}, and the transpose of the mode vector a_{RX}, as represented in Formula 4 below.

$$\begin{matrix}[ Math . 4 ] & \\ {S}_{XX} = {XX}^{T} = [ \begin{matrix}{x}_{1} {x}_{1} & {x}_{1} {x}_{2} & {x}_{1} {x}_{3} \\ {x}_{2} {x}_{1} & {x}_{2} {x}_{2} & {x}_{2} {x}_{3} \\ {x}_{3} {x}_{1} & {x}_{3} {x}_{2} & {x}_{3} {x}_{3}\end{matrix} ] = {s}^{2} \cdot {a}_{RX} ( ϕ ) {a}_{RX}^{T} ( ϕ ) & ( Formula 4 )\end{matrix}$$

In Formula 4, T indicates transpose. The product of the mode vector a_{RX} and the transpose of the mode vector a_{RX} included in the square matrix S_{XX} is represented in Formula 5 below.

$$\begin{matrix}[ Math . 5 ] & \\ {a}_{RX} ( ϕ ) {a}_{RX}^{T} ( ϕ ) = [ \begin{matrix}{e}^{- 2 j ϕ} & {e}^{- 1 j ϕ} & 1 \\ {e}^{- 1 j ϕ} & 1 & {e}^{+ 1 j ϕ} \\ 1 & {e}^{+ 1 j ϕ} & {e}^{+ 2 j ϕ}\end{matrix} ] & ( Formula 5 )\end{matrix}$$

It can be found that all five types of phases from e^{-2jφ} to e^{+2φ} included in the square matrix S_{XX} represented in Formula 5 above are continuously included without being lost.

The existing extended array processing is now described. The existing extended array processing uses a correlation matrix R_{XX} obtained by multiplying the received signal vector X by the conjugate transpose vector of X, as represented in Formula 6 below. In Formula 6 below, H indicates the conjugate transpose.

$$\begin{matrix} [ Math . 6 ] & \\ {R}_{XX} = {XX}^{H} = [ \begin{matrix}{x}_{1} {x}_{1}^{*} & {x}_{1} {x}_{2}^{*} & {x}_{1} {x}_{3}^{*} \\ {x}_{2} {x}_{1}^{*} & {x}_{2} {x}_{2}^{*} & {x}_{2} {x}_{3}^{*} \\ {x}_{3} {x}_{1}^{*} & {x}_{3} {x}_{2}^{*} & {x}_{3} {x}_{3}^{*}\end{matrix} ] = {\vert s \vert}^{2} \cdot {a}_{RX} ( ϕ ) {a}_{RX}^{H} ( ϕ ) & ( Formula 6 )\end{matrix}$$

On the other hand, in the present embodiment, the square matrix generation unit 110 multiplies the received signal vector X by the transpose vector of X to generate the square matrix S_{XX}. The reason for generating the square matrix S_{XX} is as follows.

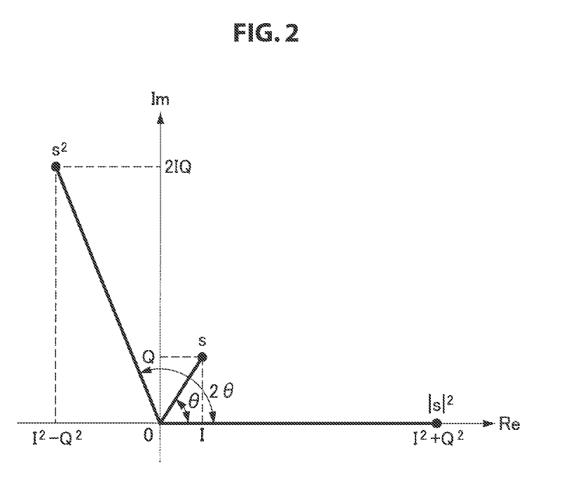

The radar echo signal s is indicated on the complex plane, as represented in Formula 7 below and as illustrated in FIG. 2.

[Math. 7]

s=1+j [symbol] =|\sqrt{I²+ [symbol] ²}|e^{jθ} (Formula 7)

It can be found that the signal component s² included in the square matrix S_{XX} includes a phase of a double angle of the original radar echo signal s, as represented in Formula 8 below and as illustrated in FIG. 2.

[Math. 8]

s²=|\sqrt{I²+ [symbol] ²}|e^{j2θ} (Formula 8)

On the other hand, the signal component |s|² included in the correlation matrix R represented in Formula 6 becomes I²+Q², as represented in Formula 9 below and as illustrated in FIG. 2. In other words, the phase information of the signal component |s|² included in the correlation matrix R_{XX} is lost.

[Math. 9]

|s|²=I²+ [symbol] ² (Formula 9)

This is the reason for generating the square matrix S_{XX} in the present embodiment. In other words, the signal processing device 100 according to the present embodiment enables the phase detection by generating the square matrix S_{XX} having the signal component s² including the phase information that lost in the existing extended array processing.

### (Extended Array Processing Unit 120)

The extended array processing unit 120 maps the elements of the square matrix S_{XX} generated by the square matrix generation unit 110 to a position where the phase coincides with an extended mode vector a_{EX} represented in Formula 10 below to generate an extended vector V_{KR}. The extended array processing unit 120 outputs the generated extended vector V_{KR} to the extended data generation unit 130.

$$\begin{matrix}[ Math . 10 ] & \\ {a}_{EX} ( ϕ ) = [ \begin{matrix}{e}^{- 2 j ϕ} \\ {e}^{- 1 j ϕ} \\ 1 \\ {e}^{+ 1 j ϕ} \\ {e}^{+ 2 j ϕ}\end{matrix} ] & ( Formula 10 )\end{matrix}$$

Each element of the square matrix S_{XX} is the dimension of power, so all the elements can be mapped to the extended vector V_{KR} by averaging the elements having overlapped phases. The extended vector V_{KR} mapped by averaging all the elements of the square matrix S_{XX} is represented in Formula 11 below.

$$\begin{matrix}[ Math . 11 ] & \\ {V}_{KR} = [ \begin{matrix}{v}_{kr 1} \\ {v}_{kr 2} \\ {v}_{kr 3} \\ {v}_{kr 4} \\ {v}_{kr 5}\end{matrix} ] = [ \begin{matrix}{x}_{1} {x}_{1} \\ ( {x}_{1} {x}_{2} + {x}_{2} {x}_{1} ) / 2 \\ ( {x}_{1} {x}_{3} + {x}_{2} {x}_{2} + {x}_{3} {x}_{1} ) / 3 \\ ( {x}_{2} {x}_{3} + {x}_{3} {x}_{2} ) / 2 \\ {x}_{3} {x}_{3}\end{matrix} ] & ( Formula 11 )\end{matrix}$$

The processing of averaging all the elements of the square matrix S_{XX} and mapping them to the extended vector V_{KR} can be integrated into the matrix operation of Formula 12 below. In Formula 12, U is a transformation matrix, and vec is a function of vectorization of column vectors of the matrix vertically.

$$\begin{matrix} [ Math . 12 ] & \\ {V}_{KR} = U vec ( {S}_{XX} ) = [ \begin{matrix}1 & 0 & 0 & 0 & 0 & 0 & 0 & 0 & 0 \\ 0 & 1 \text{/} 2 & 0 & 1 \text{/} 2 & 0 & 0 & 0 & 0 & 0 \\ 0 & 0 & 1 \text{/} 3 & 0 & 1 \text{/} 3 & 0 & 1 \text{/} 3 & 0 & 0 \\ 0 & 0 & 0 & 0 & 0 & 1 \text{/} 2 & 0 & 1 \text{/} 2 & 0 \\ 0 & 0 & 0 & 0 & 0 & 0 & 0 & 0 & 1\end{matrix} ] = [ \begin{matrix}{x}_{1} {x}_{1} \\ {x}_{2} {x}_{1} \\ {x}_{3} {x}_{1} \\ {x}_{1} {x}_{2} \\ {x}_{2} {x}_{2} \\ {x}_{3} {x}_{2} \\ {x}_{1} {x}_{3} \\ {x}_{2} x \\ {x}_{3} {x}_{3}\end{matrix} ] & ( Formula 12 )\end{matrix}$$

### (Extended Data Generation Unit 130)

The extended data generation unit 130 generates an extended data vector X_{EX} obtained by taking the square root of the amplitude for each element of the extended vector V_{KR} generated by the extended array processing unit 120. The extended data generation unit 130 outputs the generated extended data vector X_{EX} to the azimuth detection unit 140. The extended data vector X_{EX} can be generated using Formula 13 below.

$$\begin{matrix}[ Math . 13 ] & \\ {X}_{EX} = [ \begin{matrix}\sqrt{\vert {v}_{kr 1} \vert} \cdot exp \{ j arg ( {v}_{kr 1} ) \} \\ \sqrt{\vert {v}_{kr 2} \vert} \cdot exp \{ j arg ( {v}_{kr 2} ) \} \\ \sqrt{\vert {v}_{kr 3} \vert} \cdot exp \{ j arg ( {v}_{kr 3} ) \} \\ \sqrt{\vert {v}_{kr 4} \vert} \cdot exp \{ j arg ( {v}_{kr 4} ) \} \\ \sqrt{\vert {v}_{kr 5} \vert} \cdot exp \{ j arg ( {v}_{kr 5} ) \}\end{matrix} ] & ( Formula 13 )\end{matrix}$$

The reason for taking the square root of the amplitude for each element is that the element of the voltage becomes power by generating the square matrix S_{XX} and the dimension of the extended data vector X_{EX} is changed from power to voltage. In addition, the reason for the phase to remain unchanged is that the element of the extended vector V_{KR} includes both the phase of the double angle of the radar echo signal and the phase of the extended mode vector.

### (Azimuth Detection Unit 140)

The azimuth detection unit 140 estimates an arrival direction of the radar echo signal s by a predetermined azimuth estimation algorithm using the extended data vector X_{EX} generated by the extended data generation unit 130 and the extended mode vector a_{EX}. An example of the azimuth estimation algorithm includes a beamforming method, a multiple signal classification (MUSIC) method, and the like, but is not limited to a particular method. In one example, when the beamforming method is used, a function of evaluating the voltage spectrum of the radar echo signal s is represented in Formula 14 below.

[Math. 14]

E_{BF}(φ)=a_{EX}^{H}(φ)X_{EX} (Formula 14)

In Formula 14, ψ is a value determined by the distance d between elements of the reception array antenna 10, the wavelength λ of the radar signal, and the arrival angle θ of the radar echo signal as represented in Formula 2. Thus, the peak value of the waveform obtained by sweeping θ becomes the voltage of the radar echo signal s. This voltage is a complex number, so the intensity of the radar echo signal s can be obtained from the amplitude, and phase information of the double angle of the radar echo signal s can be obtained from the argument.

The radar system 1 according to the first example of the embodiment of the present disclosure having the configuration as illustrated in FIG. 1 makes it possible to enable the phase detection that failed to be achieved from the extended array processing in related art, thereby enhancing the azimuth resolution with a small number of antenna elements.

The exemplary configuration of the radar system according to the first example of the embodiment of the present disclosure is described above. Then, an exemplary operation of the radar system according to the first example of the embodiment of the present disclosure is described.

### (Exemplary Operation of Radar System)

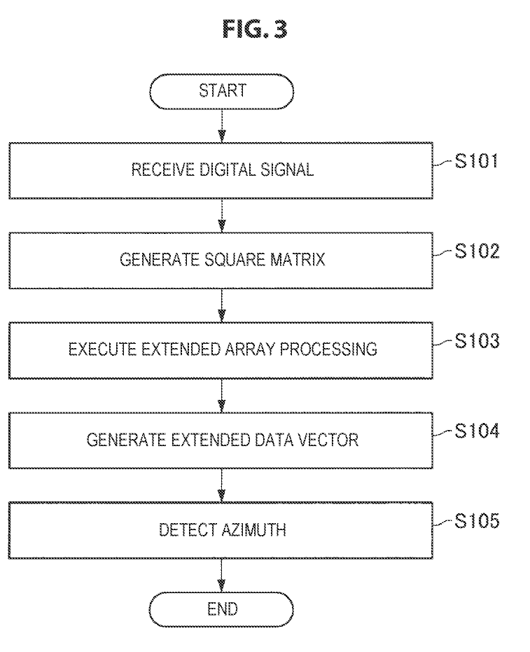

FIG. 3 is a flowchart illustrating an exemplary operation of the radar system 1 according to the first example of the embodiment of the present disclosure. An exemplary operation of the radar system 1 according to the first example of the embodiment of the present disclosure is now described with reference to FIG. 3.

The radar system 1, when receiving the radar echo signal s by the reception array antenna 10, causes the reception processing units 30-1, 30-2, and 30-3 to perform predetermined processing, for example, amplification, frequency conversion, and frequency filtering on the radar echo signal s arriving at the reception array antenna 10. The signal processing device 100 receives digital signals from the reception processing units 30-1, 30-2, and 30-3 (step S101).

Subsequently, the signal processing device 100 generates a square matrix from the received signal vector including the digital signals (step S102). The generation of the square matrix can be executed by, in one example, the square matrix generation unit 110.

When the square matrix is generated, the signal processing device 100 subsequently executes the extended array processing for generating an extended vector from the square matrix (step S103). The generation of the extended vector can be executed by, in one example, the extended array processing unit 120.

When the extended array processing is executed, the signal processing device 100 subsequently takes the square root of the amplitude of each element of the extended vector to generate an extended data vector (step S104). The generation of the extended data vector can be executed by, in one example, the extended data generation unit 130.

When the extended data vector is generated, the signal processing device 100 subsequently performs the azimuth detection processing of estimating the arrival direction of the radar echo signal using the extended data vector to obtain information related to phase and intensity (step S105). The azimuth detection processing can be executed by, in one example, the azimuth detection unit 140.

The radar system 1 according to the first example of the embodiment of the present disclosure executes a series of operations as illustrated in FIG. 3 to enable the phase detection that failed to be achieved from the extended array processing in related art, thereby enhancing the azimuth resolution with a small number of antenna elements.

In other words, according to the first example of the embodiment of the present disclosure, it is possible to provide the radar system 1 and the method of processing the radar signal, capable of enabling the phase detection of the radar echo signal and achieving the azimuth resolution enhancement, by extending the number of elements of the antenna by performing the extended array processing on the matrix obtained by squaring the radar echo signal.

### 1.3. Second Example

### (Exemplary Configuration of Radar System)

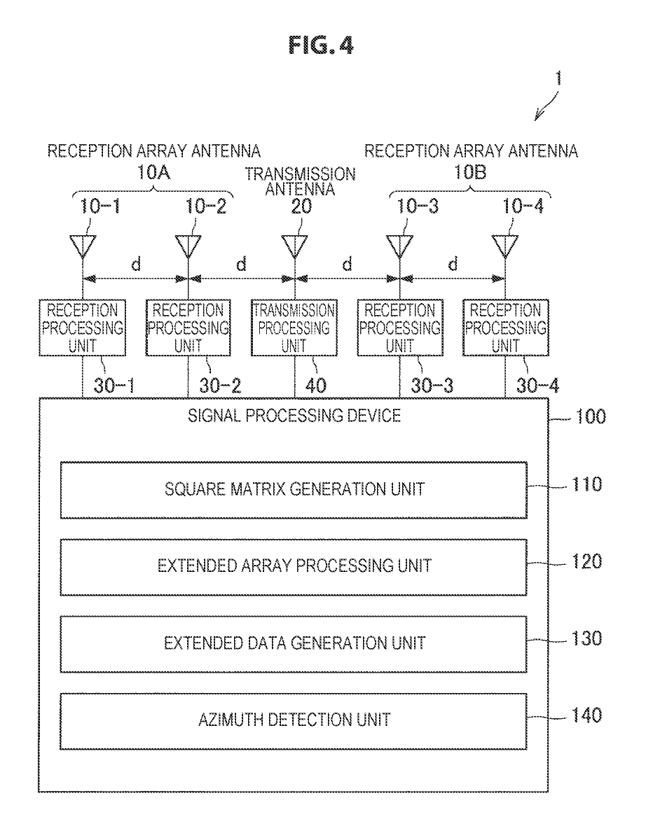

An exemplary configuration of a radar system according to a second example of the embodiment of the present disclosure is now described. FIG. 4 is a diagram illustrated to describe an exemplary configuration of the radar system 1 according to the second example of the embodiment of the present disclosure. An exemplary configuration of the radar system 1 according to the second example of the embodiment of the present disclosure is described below with reference to FIG. 4.

The radar system 1 illustrated in FIG. 4 has a configuration in which a transmission antenna is located between reception array antennas. The radar system 1 illustrated in FIG. 4 includes the reception array antennas 10A and 10B, the transmission antenna 20, and a signal processing device 100. In addition, the signal processing device 100 includes a square matrix generation unit 110, an extended array processing unit 120, an extended data generation unit 130, and an azimuth detection unit 140. The signal processing device 100 has the same configuration as that illustrated in FIG. 1, so detailed description thereof will be omitted.

The reception array antennas 10A and 10B are linear array antennas each having L elements (where L is a natural number of 2 or more), and the distance d between the elements are equally spaced. In the radar system 1 illustrated in FIG. 4, the reception array antenna 10A includes reception antennas 10-1 and 10-2, and the reception array antenna 10B includes reception antennas 10-3 and 10-4. In other words, the number of elements, L, is 2 in each case. Then, the interval between the reception array antennas 10A and 10B is set to L×d or less. Moreover, the number of elements of the reception array antennas 10A and 10B can be identical or different.

In the radar system 1 illustrated in FIG. 4, the mode vector a_{RX} is obtained as represented in Formula 15 below.

$$\begin{matrix}[ Math . 15 ] & \\ {a}_{RX} ( ϕ ) = [ \begin{matrix}{e}^{- 2 j ϕ} \\ {e}^{- 1 j ϕ} \\ {e}^{+ 1 j ϕ} \\ {e}^{+ 2 j ϕ}\end{matrix} ] & ( Formula 15 )\end{matrix}$$

The square matrix S_{XX} is represented as Formula 16, and the product of the mode vector a_{RX} included in the square matrix S_{XX} and the transpose of the mode vector a_{RX} is represented as Formula 17.

$$\begin{matrix} [ Math . 16 ] & \\ {S}_{XX} = {s}^{2} \cdot {a}_{RX} ( ϕ ) {a}_{RX}^{T} ( ϕ ) = [ \begin{matrix}{x}_{1} {x}_{1} & {x}_{1} {x}_{2} & {x}_{1} {x}_{3} & {x}_{1} {x}_{4} \\ {x}_{2} {x}_{1} & {x}_{2} {x}_{2} & {x}_{2} {x}_{3} & {x}_{2} {x}_{4} \\ {x}_{3} {x}_{1} & {x}_{3} {x}_{2} & {x}_{3} {x}_{3} & {x}_{3} {x}_{4} \\ {x}_{4} {x}_{1} & {x}_{4} {x}_{2} & {x}_{4} {x}_{3} & {x}_{4} {x}_{4}\end{matrix} ] & ( Formula 16 ) \\ [ Math . 17 ] & \\ {a}_{RX} ( ϕ ) {a}_{RX}^{T} ( ϕ ) = [ \begin{matrix}{e}^{- 4 j ϕ} & {e}^{- 3 j ϕ} & {e}^{+ 1 j ϕ} & 1 \\ {e}^{- 3 j ϕ} & {e}^{- 2 j ϕ} & 1 & {e}^{+ 1 j ϕ} \\ {e}^{- 1 j ϕ} & 1 & {e}^{+ 2 j ϕ} & {e}^{+ 3 j ϕ} \\ 1 & {e}^{+ 1 j ϕ} & {e}^{+ 3 j ϕ} & {e}^{+ 4 j ϕ}\end{matrix} ] & ( Formula 17 )\end{matrix}$$

Referring to Formula 17, all nine types of phases from e^{-4jψ} to e^{+4jψ} are continuously included without being lost, and the interval between the right end of the reception array antenna 10A and the left end of the reception array antenna 10B is limited to L×d or less, so Formula 17 is ensured to include all elements of the extended mode vector a_{EX} of Formula 18 below.

[Math. 18]

a_{EX}(φ)=[e^{-1j}φe^{-jφ}e^{-jφ}1e^{+1jφ}e^{2jφ}e^{+3jφ}e^{+4jφ}]^{T} (Formula 18)

The extended vector V_{KR} mapped by averaging all elements of the square matrix S_{XX} indicated in Formula 16 is represented in Formula 19.

$$\begin{matrix}[ Math . 19 ] & \\ {V}_{KR} = [ \begin{matrix}{x}_{1} {x}_{1} \\ ( {x}_{1} {x}_{2} + {x}_{2} {x}_{1} ) / 2 \\ {x}_{2} {x}_{2} \\ ( {x}_{1} {x}_{3} + {x}_{3} {x}_{1} ) / 2 \\ ( {x}_{1} {x}_{4} + {x}_{2} {x}_{3} + {x}_{3} {x}_{2} + {x}_{4} {x}_{1} ) / 4 \\ ( {x}_{2} {x}_{4} + {x}_{4} {x}_{2} ) / 2 \\ {x}_{3} {x}_{3} \\ ( {x}_{3} {x}_{4} + {x}_{4} {x}_{3} ) / 2 \\ {x}_{4} {x}_{4}\end{matrix} ] & ( Formula 19 )\end{matrix}$$

Further, the processing of mapping from the square matrix S_{XX} in Formula 16 to the extended vector V_{KR} is represented in Formula 20.

$$\begin{matrix} [ Math . 20 ] & \\ {V}_{KR} = U vec ( {S}_{XX} ) \\ U = [ \begin{matrix}1 & 0 & 0 & 0 & 0 & 0 & 0 & 0 & 0 & 0 & 0 & 0 & 0 & 0 & 0 & 0 \\ 0 & 1 \text{/} 2 & 0 & 0 & 1 \text{/} 2 & 0 & 0 & 0 & 0 & 0 & 0 & 0 & 0 & 0 & 0 & 0 \\ 0 & 0 & 0 & 0 & 0 & 1 & 0 & 0 & 0 & 0 & 0 & 0 & 0 & 0 & 0 & 0 \\ 0 & 0 & 1 \text{/} 2 & 0 & 0 & 0 & 0 & 0 & 1 \text{/} 2 & 0 & 0 & 0 & 0 & 0 & 0 & 0 \\ 0 & 0 & 0 & 1 \text{/} 4 & 0 & 0 & 1 \text{/} 4 & 0 & 0 & 1 \text{/} 4 & 0 & 0 & 1 \text{/} 4 & 0 & 0 & 0 \\ 0 & 0 & 0 & 0 & 0 & 0 & 0 & 1 \text{/} 2 & 0 & 0 & 0 & 0 & 0 & 1 \text{/} 2 & 0 & 0 \\ 0 & 0 & 0 & 0 & 0 & 0 & 0 & 0 & 0 & 0 & 1 & 0 & 0 & 0 & 0 & 0 \\ 0 & 0 & 0 & 0 & 0 & 0 & 0 & 0 & 0 & 0 & 0 & 1 \text{/} 2 & 0 & 0 & 1 \text{/} 2 & 0 \\ 0 & 0 & 0 & 0 & 0 & 0 & 0 & 0 & 0 & 0 & 0 & 0 & 0 & 0 & 0 & 1\end{matrix} ] \\ vec ( {S}_{XX} ) = {[ \begin{matrix}{x}_{1} {x}_{1} & {x}_{2} {x}_{1} & {x}_{3} {x}_{1} & {x}_{4} {x}_{1} & {x}_{1} {x}_{2} & {x}_{2} {x}_{2} & {x}_{3} {x}_{2} & {x}_{4} {x}_{2} & {x}_{1} {x}_{3} & {x}_{2} {x}_{3} & {x}_{3} {x}_{3} & {x}_{4} {x}_{3} & {x}_{1} {x}_{4} & {x}_{2} {x}_{4} & {x}_{3} {x}_{4} & {x}_{4} {x}_{4}\end{matrix} ]}^{T} & ( Formula 20 )\end{matrix}$$

The signal processing device 100 is then capable of generating an extended data vector X_{EX} obtained by taking the square root of the amplitude for each element of the extended vector V_{KR}, and capable of estimating the arrival direction of the radar echo signal s with a predetermined azimuth estimation algorithm by using the extended data vector X_{EX} and the extended mode vector a_{EX}.

### 2. Concluding Remarks

According to the embodiment of the present disclosure as described above, there is provided the signal processing device 100 used in a particularly small radar system and capable of enabling phase detection that failed to be achieved from the extended array processing in related art and enhancing the azimuth resolution with a small number of elements. In addition, according to the embodiment of the present disclosure, there is provided the radar system 1 using the signal processing device 100 capable of enhancing the azimuth resolution with the number of antenna elements.

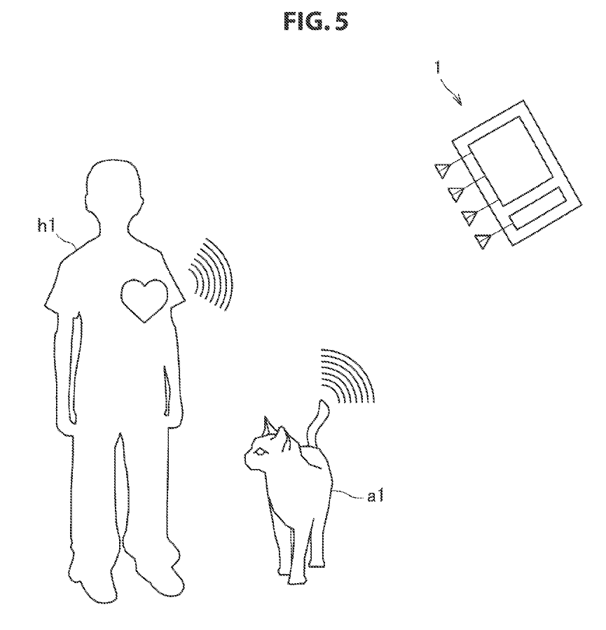

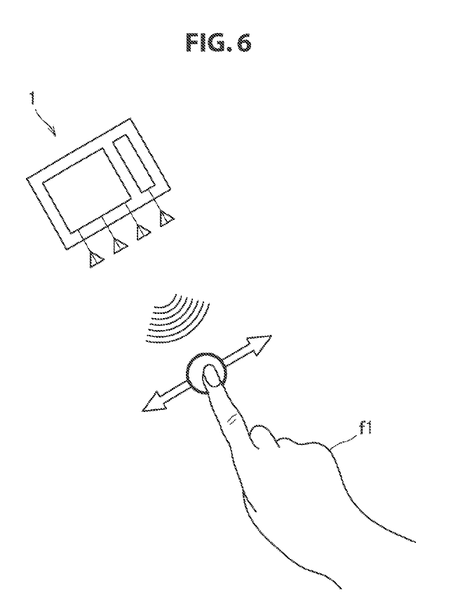

The radar system 1 according to the embodiment of the present disclosure is compact, but is capable of having enhanced azimuth resolution and detecting minute movement, so it can be used for compact radar intended for monitoring, care, or user interface operated by gesture input. In one example, as illustrated in FIG. 5, the radar system 1 can be used for the monitoring of a person h1 or an animal a1. In addition, in one example, as illustrated in FIG. 6, the radar system 1 can be used for detection of a gesture input using a user's finger f1.

The above-mentioned types of use are certainly merely one example of the types of use of the radar system 1 according to the embodiment of the present disclosure.

The respective steps in the processing executed by each device described herein are not necessarily processed in chronological order in accordance with the sequence shown in the sequence diagram or the flowchart. In one example, the respective steps in the processing executed by each device can be processed in a sequence different from that shown in the flowchart, or processed in parallel.

Further, it is also possible to create a computer program for causing the hardware such as CPU, ROM, and RAM incorporated in each device to perform functions equivalent to those of components of the above-described devices. In addition, it is possible to provide a storage medium having such computer program stored therein. In addition, each functional block shown in the functional block diagram can be configured as hardware or hardware circuitry, so a series of processing steps can be implemented by such hardware or hardware circuitry.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A signal processing device including:

a matrix generation unit configured to generate a matrix by multiplying a received signal vector of a reception signal by a transpose vector of the received signal vector, the reception signal being received by a reception array antenna including a plurality of reception antennas; and

an estimation unit configured to estimate at least a phase of the reception signal on a basis of the matrix.

(2)

The signal processing device according to claim 1, further including:

a first vector generation unit configured to generate a first vector by performing an operation on the matrix; and

a second vector generation unit configured to generate a second vector by performing a predetermined operation on each element of the first vector,

in which the estimation unit estimates at least the phase of the reception signal using the second vector.

(3)

The signal processing device according to claim 2,

in which the first vector generation unit generates the first vector by mapping an element of the matrix to a position corresponding to a phase.

(4)

The signal processing device according to claim 2,

in which the second vector generation unit generates the second vector by converting a value corresponding to an amplitude of each element of the first vector into a square root.

(5)

The signal processing device according to claim 1,

in which the estimation unit further estimates an arrival direction and intensity of the reception signal.

(6)

The signal processing device according to claim 1,

in which the reception array antenna has L elements (where L is an integer of 2 or more) arranged in a line shape with a distance d between the elements.

(7)

The signal processing device according to claim 1,

in which the reception array antenna includes a first reception array antenna and a second reception array antenna, the first reception array antenna having L elements (where L is an integer of 2 or more) arranged in a line shape with a distance d between the elements, the second reception array antenna having M elements (where M is an integer of 2 or more) arranged in a line shape with a distance d between the elements, the second reception array antenna being spaced with a distance of L×d or less in a direction identical to an arrangement direction of the first reception array antenna.

(8)

A signal processing method including:

generating a matrix by multiplying a received signal vector of a reception signal by a transpose vector of the received signal vector, the reception signal being received by a reception array antenna including a plurality of reception antennas; and estimating at least a phase of the reception signal on a basis of the matrix.

(9)

A signal reception device including:

a reception array antenna including a plurality of reception antennas arranged at a predetermined interval;

a matrix generation unit configured to generate a matrix by multiplying a received signal vector of a reception signal received by the reception array antenna by a transpose vector of the received signal vector; and

an estimation unit configured to estimate at least a phase of the reception signal on a basis of the matrix.

(10)

The signal reception device according to claim 7,

in which the reception array antenna has L elements (where L is an integer of 2 or more) arranged in a line shape with a distance d between the elements.

(11)

The signal reception device according to claim 7,

in which the reception array antenna includes a first reception array antenna and a second reception array antenna, the first reception array antenna having L elements (where L is an integer of 2 or more) arranged in a line shape with a distance d between the elements, the second reception array antenna having M elements (where M is an integer of 2 or more) arranged in a line shape with a distance d between the elements, the second reception array antenna being spaced with a distance of L×d or less in a direction identical to an arrangement direction of the first reception array antenna.

### REFERENCE SIGNS LIST

1 radar system
10 reception array antenna
10-1 reception antenna
10-2 reception antenna
10-3 reception array antenna
10-4 reception array antenna
10A reception array antenna
10B reception array antenna
transmission antenna
a1 animal
f1 finger
h1 person

1. A signal processing device comprising:
a matrix generation unit configured to generate a matrix by multiplying a received signal vector of a reception signal by a transpose vector of the received signal vector, the reception signal being received by a reception array antenna including a plurality of reception antennas; and
an estimation unit configured to estimate at least a phase of the reception signal on a basis of the matrix.

2. The signal processing device according to claim 1, further comprising:
a first vector generation unit configured to generate a first vector by performing an operation on the matrix; and
a second vector generation unit configured to generate a second vector by performing a predetermined operation on each element of the first vector,
wherein the estimation unit estimates at least the phase of the reception signal using the second vector.

3. The signal processing device according to claim 2,
wherein the first vector generation unit generates the first vector by mapping an element of the matrix to a position corresponding to a phase.

4. The signal processing device according to claim 2,
wherein the second vector generation unit generates the second vector by converting a value corresponding to an amplitude of each element of the first vector into a square root.

5. The signal processing device according to claim 1,
wherein the estimation unit further estimates an arrival direction and intensity of the reception signal.

6. The signal processing device according to claim 1,
wherein the reception array antenna has L elements (where L is an integer of 2 or more) arranged in a line shape with a distance d between the elements.

7. The signal processing device according to claim 1,
wherein the reception array antenna includes a first reception array antenna and a second reception array antenna, the first reception array antenna having L elements (where L is an integer of 2 or more) arranged in a line shape with a distance d between the elements, the second reception array antenna having M elements (where M is an integer of 2 or more) arranged in a line shape with a distance d between the elements, the second reception array antenna being spaced with a distance of L×d or less in a direction identical to an arrangement direction of the first reception array antenna.

8. A signal processing method comprising:
generating a matrix by multiplying a received signal vector of a reception signal by a transpose vector of the received signal vector, the reception signal being received by a reception array antenna including a plurality of reception antennas; and
estimating at least a phase of the reception signal on a basis of the matrix.

9. A signal reception device comprising:
a reception array antenna including a plurality of reception antennas arranged at a predetermined interval;
a matrix generation unit configured to generate a matrix by multiplying a received signal vector of a reception signal received by the reception array antenna by a transpose vector of the received signal vector; and
an estimation unit configured to estimate at least a phase of the reception signal on a basis of the matrix.

10. The signal reception device according to claim 7,
wherein the reception array antenna has L elements (where L is an integer of 2 or more) arranged in a line shape with a distance d between the elements.

11. The signal reception device according to claim 7,
wherein the reception array antenna includes a first reception array antenna and a second reception array antenna, the first reception array antenna having L elements (where L is an integer of 2 or more) arranged in a line shape with a distance d between the elements, the second reception array antenna having M elements (where M is an integer of 2 or more) arranged in a line shape with a distance d between the elements, the second reception array antenna being spaced with a distance of L×d or less in a direction identical to an arrangement direction of the first reception array antenna.
